(19) United States
(12) Patent Application Publication
(10) Pub. No.: US 2026/0129717 A1
(43) Pub. Date: May 7, 2026

(54) EMERGENCY CALLS ON TEXT-ONLY RESTRICTED NETWORKS

(71) Applicant: T-Mobile USA, Inc., Bellevue, WA (US)

(72) Inventors: Manuel A. Garcia, Miami, FL (US); Jongik Lee, Bellevue, WA (US); Morgan Brittany Mackaay, Bellevue, WA (US); Ahsaan Rizvi, Ontario (CA); Nitin Verma, Bellevue, WA (US)

(21) Appl. No.: 18/935,389

(22) Filed: Nov. 1, 2024

(51) Int. Cl. H04W 76/50; H04W 4/90

(52) U.S. Cl. CPC H04W 76/50; H04W 4/90

(57) ABSTRACT

Methods, devices, and systems related to handling emergency calls in restricted networks are disclosed. In one example aspect, a method for wireless communication includes receiving a request from a user to initiate a call for an emergency using a mobile device and providing a voice message to the user upon determining that the mobile device is operating using a restricted connection. The voice message prompts the user to provide information about the emergency. The method includes converting the information provided by the user to a first set of text messages and transmitting the first set of text messages to an emergency service using the restricted connection.

### BACKGROUND

Emergency calling allows police, fire departments, or other first responders to quickly respond to an emergency at a location. Enhanced emergency calling automatically gives the dispatcher the caller's location, if available, to allow timely handling of emergency situations.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates Fifth Generation (5G) core network functions (NFs) that can implement aspects of the present technology.

FIG. 3 illustrates an example of how emergency calling works.

FIG. 4 illustrates an example of an existing user interface that allows only emergency texts for satellite networks.

FIG. 5 illustrates an example flow diagram in accordance with one or more embodiments of the present technology.

FIG. 6 illustrates an example Artificial Intelligence (AI)/Machine Learning (ML) system in accordance with one or more embodiments of the present technology.

FIG. 7 illustrates an example touchtone translation system integrated into an example AI-based emergency response service in accordance with one or more embodiments of the present technology.

FIG. 8A illustrates an example trilateration that leverages information from multiple beams or multiple satellites in accordance with one or more embodiments of the present technology.

FIG. 8B illustrates an example of using signal strength from the device to determine the distance between the device and the beam/satellite in accordance with one or more embodiments of the present technology.

FIG. 8C illustrates an example of using Bluetooth Low Energy (BLE) advertising among devices in accordance with one or more embodiments of the present technology.

FIG. 8D illustrates an example of embedding location information in messages in accordance with one or more embodiments of the present technology.

FIG. 9A is a flowchart representation of a method for wireless communication in accordance with one or more embodiments of the present technology.

FIG. 9B is a flowchart representation of a method for information conversion in accordance with one or more embodiments of the present technology.

FIG. 10 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Emergency calling allows users in emergency situations to get prompt help from safety agencies. However, for users in rural areas, network connection may be restricted in a sense that only a particular type of low-bandwidth data can be transmitted due to bandwidth limitation, making emergency calls and timely communication of the emergency difficult. This patent document discloses techniques that can be implemented in various embodiments to enable a user to initiate emergency calls as usual when the network connection is restricted. Voice data from the user during the emergency call is converted to low-bandwidth formats such as text messages for transmission in restricted networks. The messages can be further supplemented with locational data for the user device to enable the public safety agents to determine the location of the user more accurately for prompt actions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

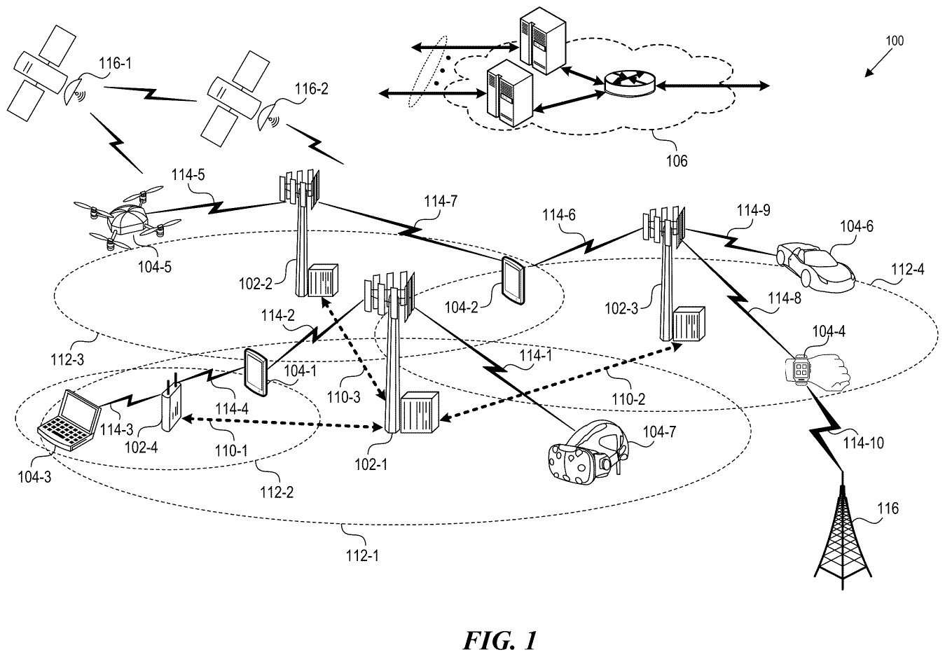

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

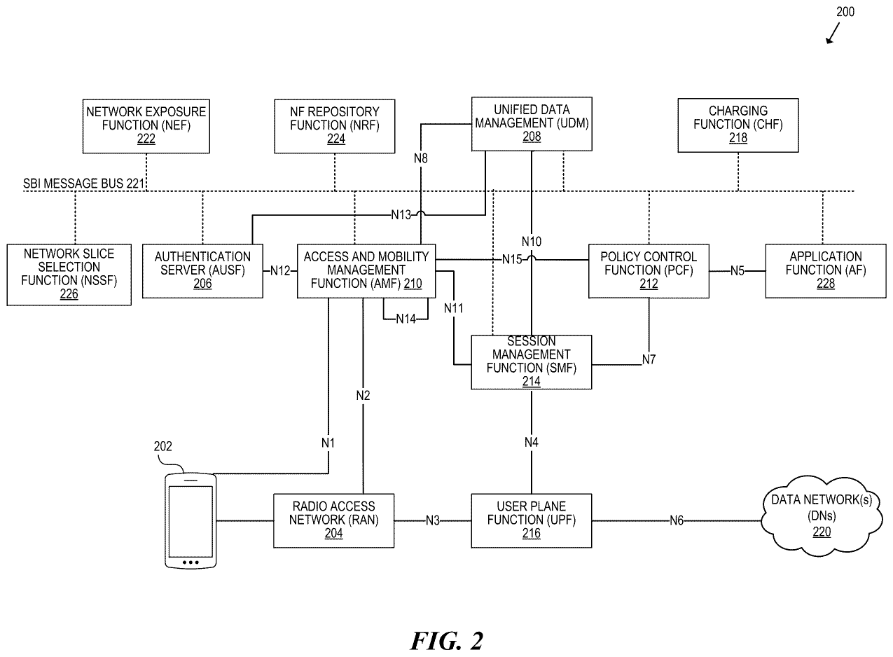

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Emergency Calls in Text-only Networks

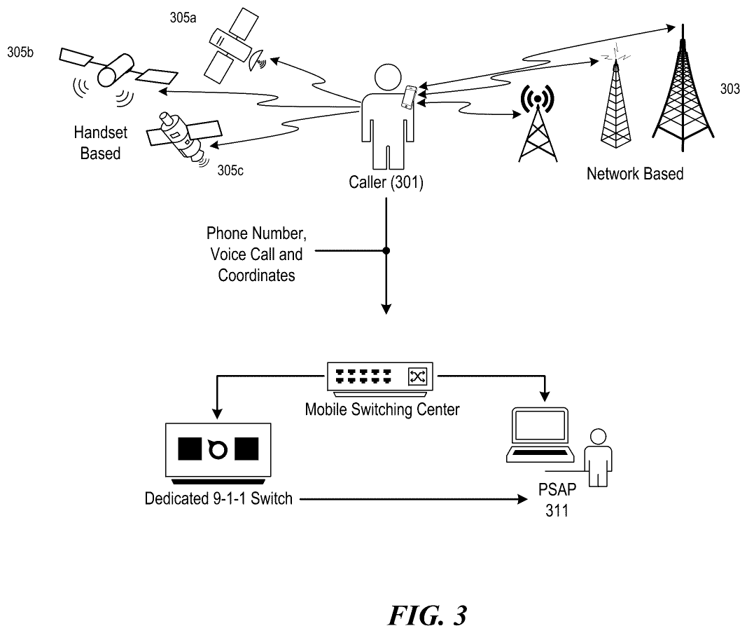

Emergency calling allows users in emergency situations to get prompt help from safety agencies. In most parts of North America, dialing 911 from any telephone links, wired or wireless, leads the caller to a public safety answering point (PSAP) that can send emergency responders to the caller's location in an emergency. FIG. 3 illustrates an example of how emergency calling, particularly enhanced emergency (E911) calling, works. As shown in FIG. 3, a caller 301 dials 911 and the call is routed to a PSAP 311. In Phase 1 of the call handling, the call taker at PSAP can obtain the cell phone number of the caller and the location of the cell tower antenna the phone is using. In this example, the call has been routed to the PSAP 311 nearest to that tower 303. Phase I technology can locate a cell phone within a 6 to 30-mile radius of a cell tower.

In Phase II of the call handling, the call taker at PSAP 311 can see the cell phone number and the location of the caller to an accuracy of 50 to 300 meters, based on the type of location system being used by the wireless provider. Currently, there is no standardized method of implementing Phase II, so wireless providers, in conjunction with local public safety agencies, are using various setups for providing cell phone location information to PSAPs. There are two basic approaches: handset-based and network-based. The handset-based approach leverages the Global Positioning System (GPS) receiver built into the handset. When the user dials 911 on the phone, the GPS receiver locates itself using satellites orbiting overhead. Using trilateration based on signals from at least three satellites (e.g., 305a-305c), for example, the caller device can determine its location. The network-based solution leverages cellular cell towers or base stations (e.g., 303) to provide the locational information, such as the coordinates, of the caller device.

In rural areas, coverage of cellular networks can be less optimal, and satellite networks allow users to stay connected. For example, low earth orbit (LEO) networks have multiple satellites orbiting Earth at an altitude of 1,000 miles or less (e.g., Starlink). The satellites are constantly on the move to provide coverage for users. When one moves out of range, the communication is handed off to another satellite that is within range to provide connectivity to the users.

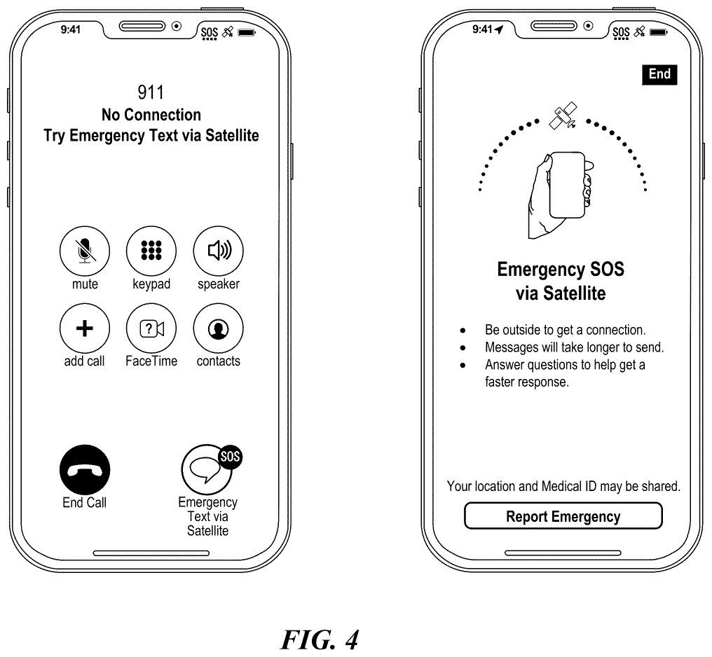

However, due to the bandwidth limitations of satellite networks, transmissions to and from the satellite may be limited to text format only. Currently, emergency communication using satellite networks is only available in the format of text messages. FIG. 4 illustrates an example of an existing user interface that allows only emergency texts for satellite networks. As shown in FIG. 4, when a user attempts to call 911 during an emergency, the user is notified that a call cannot be completed and is forced to switch to emergency text via satellite. Manually entering text messages in an emergency situation, however, can be difficult. This can cause confusion, delay, and frustration for users during an emergency situation. Furthermore, without radiolocation information from the cellular network, in the network-based solution mentioned above, accurately locating the user on such a restricted network may be difficult as well.

This patent document discloses techniques that can be implemented in various embodiments to enable a user to initiate emergency calls as usual when the network connection is restricted. The network connection is restricted when its bandwidth is restricted such that only a particular type of low-bandwidth data can be transmitted. For example, having satellite connection only can be considered as operating using a restricted connection. Using the disclosed techniques, the user is able to provide emergency information through voice communication without the need to manually switch to low-bandwidth text input. A software program deployed on the user device (e.g., a network operator application) can convert user's input in the form of voice data or numerical selection (e.g., touchtone selection) to outbound messages in the text format for transmission in restricted networks. Response from the emergency operators is relayed and translated back to the user on the same voice call in real time, offering the same user experience as emergency calls on cellular networks. In some embodiments, the outbound messages further include customer identification information such as automatic location identification (ALI), automatic number identification (ANI), and/or device location (e.g., latitude/longitude). Furthermore, diagnostics data can be collected by the software program during the emergency handling process. The diagnostic data can be uploaded to the cellular network once cellular coverage is restored, thereby enabling analysis of the emergency situation handling and improvement of the emergency services.

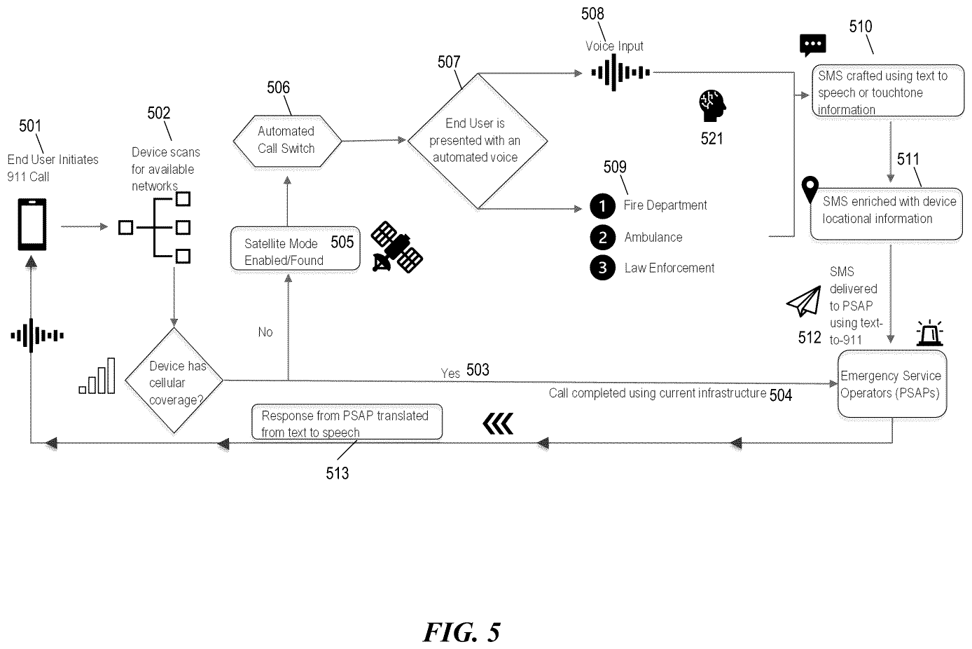

FIG. 5 illustrates an example flow diagram in accordance with one or more embodiments of the present technology. At operation 501, an end user can initiate an emergency call when the device is connected to a restricted network (e.g., a satellite network). The user can initiate such a call using the same user interface for initiating a regular emergency call in cellular network to minimize confusion or frustration of the user. At operation 502, the user device scans for available networks. If a cellular network coverage is available for the emergency call (operation 503), the call is routed to the PSAPs using existing network infrastructure (operation 504). If no cellular network coverage is available, the satellite connection mode is enabled (operation 505). The emergency call is automatically switched to the satellite mode at operation 506 to enable a locally deployed software program (e.g., a network operator application) to assist the subsequent steps in the emergency call process. In the satellite mode, the user can be presented with an automated voice message (operation 507) asking for the nature of the emergency (e.g., medical issues, crime, etc.). The user's voice answer (operation 508) is captured and translated to texts using techniques such as AI. Alternatively, or in addition, e.g., when the voice answer is incomprehensible, the user may be prompted to provide a touchtone answer (operation 509) to select the proper emergency type (e.g., fire department, ambulance, law enforcement). At operation 510, a Short Message Service (SMS) message is generated using the captured voice and/or the touchtone input provided by the user. At operation 511, the generated message is further supplemented with locational information, such as the device latitude, longitude, ALI, ANI, etc. The text message is then delivered to PSAPs at operation 512. At operation 513, the response from the PSAPs is converted from text to speech to simulate a real call with the PSAPs to reduce confusion and/or anxiety on the user side.

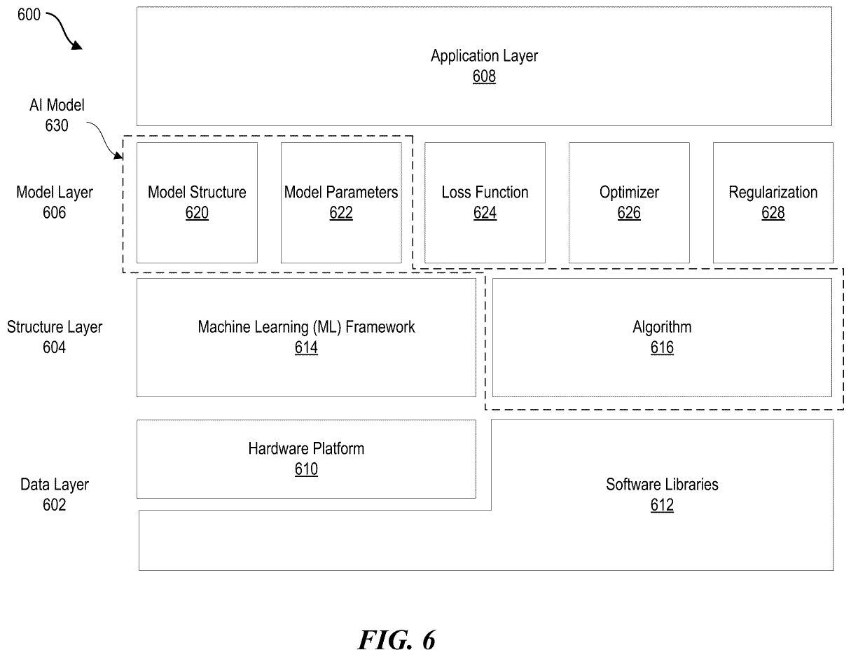

In some scenarios, the voice input provided by the user may include background noises. In some cases, the user speech may be unrecognizable due to accents or language barriers. In those cases, AI technology can be leveraged to help filter out the noise in the the voice input and translate the voice input into appropriate language(s) if needed. As shown in FIG. 5, one or more AI modules 521 can be incorporated as part of the locally deployed software program to enable the conversion between voice and text information. FIG. 6 illustrates an example AI/ML system in accordance with one or more embodiments of the present technology. As shown in FIG. 6, the AI/ML system 600 can include a set of layers, which conceptually organize elements within an example network topology for the AI system's architecture to implement a particular AI/ML model 630. Generally, an AI/ML model 630 is a computer-executable program implemented by the AI/ML system 600 that analyzes data to make predictions. In some embodiments, the AI/ML model 630 can be deployed on the user device (e.g., the user device can download the AI/ML model(s) 630 from a server when it has cellular connection). The remaining part of the AI system is deployed in a server of the core network operated by the network operator. Information can pass through each layer of the AI/ML system 600 to generate outputs for the AI/ML model 630. The layers can include a data layer 602, a structure layer 604, a model layer 606, and an application layer 608. An algorithm 616 of the structure layer 604 and a model structure 620 and model parameters 622 of the model layer 606 together form the example AI/ML model 630. A loss function engine 624, an optimizer 626, and a regularization engine 628 work to refine and optimize the AI/ML model 630, and the data layer 602 provides resources and support for application of the AI/ML model 630 by the application layer 608.

The data layer 602 acts as the foundation of the AI/ML system 600 by preparing data for the AI/ML model 630. As shown, the data layer 602 can include two sub-layers: a hardware platform 610 and one or more software libraries 612. The hardware platform 610 can be designed to perform operations for the AI/ML model 630 and include computing resources for storage, memory, logic, and networking. The hardware platform 610 can process amounts of data using one or more cores, such as central processing units (CPUs) and/or graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources (e.g., servers, memory, etc.) offered by a cloud services provider. The hardware platform 610 can also include computer memory for storing data about the AI/ML model 630, application of the AI/ML model 630, and training data for the AI/ML model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI/ML system 600 include Intel Math Kernel Library, Nvidia cuDNN, Eigen, and Open BLAS.

The structure layer 604 can include an AI/ML framework 614 and the algorithm 616. The AI/ML framework 614 can be thought of as an interface, library, or tool that allows network carriers to build and deploy the AI/ML model 630. The AI/ML framework 614 can include an open-source library, an application programming interface (API), a gradient-boosting library, an ensemble method, and/or a deep learning toolkit that work with the layers of the AI/ML system 600 to facilitate development of the AI/ML model 630. For example, the AI/ML framework 614 can distribute processes for application or training of the AI/ML model 630 across multiple resources in the hardware platform 610. The AI/ML framework 614 can also include a set of pre-built components that have the functionality to implement and train the AI/ML model 630 and allow network carriers to use pre-built functions and classes to construct and train the AI/ML model 630. Thus, the AI/ML framework 614 can be used to facilitate data engineering, development, hyperparameter tuning, testing, and training for the AI/ML model 630. Examples of AI/ML frameworks 614 that can be used in the AI/ML system 600 include TensorFlow, PyTorch, Scikit-Learn, Keras, Cafffe, LightGBM, Random Forest, and Amazon Web Services.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI/ML model 630 through being trained while running computing resources of the hardware platform 610. This training allows the algorithm 616 to make predictions or decisions without being explicitly programmed to do so. Once trained, the algorithm 616 can run at the computing resources as part of the AI/ML model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. For instance, data collected from core network and/or radio access nodes is preprocessed to form a set of training data. The network carrier may label the training data based on the data and train the AI/ML model 630 by inputting the training data to the algorithm 616. In some instances, as mentioned above, the training data is converted to a set of features or feature vectors for input to the algorithm 616. Once trained, the algorithm 616 can be validated on new data to determine whether the algorithm 616 is predicting accurate labels for the new data.

Supervised learning can involve classification and/or regression. Classification techniques involve teaching the algorithm 616 to identify a category of new observations based on training data and are used when input data for the algorithm 616 is discrete. Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification. Under unsupervised learning, the algorithm 616 learns patterns from unlabeled training data. In particular, the algorithm 616 is trained to learn hidden patterns and insights of input data, which can be used for data exploration or for generating new data. Said another way, unsupervised learning is used to train the algorithm 616 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has fewer or no similarities to another group. Examples of clustering techniques include density-based methods, hierarchical-based methods, partitioning methods, and grid-based methods. In one example, the algorithm 616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or k-NN algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 616 include factor analysis, item response theory, latent profile analysis, and latent class analysis.

The model layer 606 implements the AI/ML model 630 using data from the data layer 602 and the algorithm 616 and AI/ML framework 614 from the structure layer 604, thus enabling decision-making capabilities of the AI/ML system 600. The model layer 606 includes the model structure 620, model parameters 622, the loss function engine 624, the optimizer 626, and the regularization engine 628.

The model structure 620 describes the architecture of the AI/ML model 630 of the AI/ML system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how the node converts data received to data output. The structure layers may include an input layer of nodes that receive input data and an output layer of nodes that produce output data. The model structure 620 may include one or more hidden layers of nodes between the input and output layers. The model structure 620 can be a neural network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the performance of the AI/ML model 630 during training. For instance, the loss function engine 624 can measure the difference between a predicted output of the AI/ML model 630 and the actual output of the AI/ML model 630 and is used to guide optimization of the AI/ML model 630 during training to minimize the loss function. The loss function may be presented via the AI/ML framework 614, such that a network carrier can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI/ML model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents over-and underfitting of the AI/ML model 630. Overfitting occurs when the algorithm 616 is overly complex and too adapted to the training data, which can result in poor performance of the AI/ML model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constrain the resulting AI/ML model 630 and improves its ability for generalized application. Examples of regularization techniques include lasso (L1) regularization, ridge (L2) regularization, and elastic (L1 and L2) regularization. The use of AI/ML techniques can greatly improve the accuracy for converting/translating multiple languages, with or without accents.

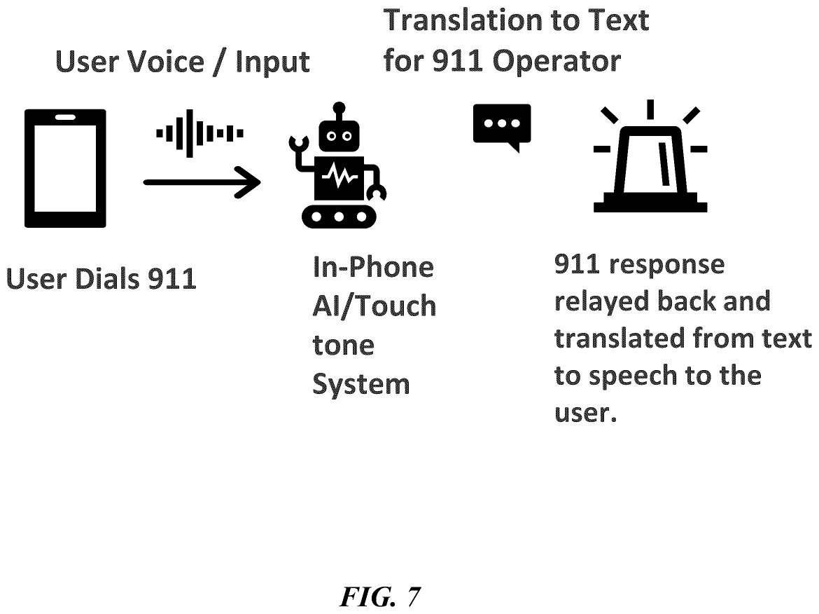

FIG. 7 illustrates an example touchtone translation system integrated into an example AI-based emergency response service in accordance with one or more embodiments of the present technology. Integrating a touchtone translation system into the AI-based emergency response service allows users to input emergency details using the keypad, as an alternative or in addition to voice input. When a user dials 911, a simultaneous automated system is enabled while the speech-to-text conversion attempts to gather details from voice input. The system prompts the user to enter their emergency details using the keypad, such as pressing “1” for medical emergency, “2” for fire, or “3” for police assistance. The information is then relayed via Text-to-911 operators and the communication is established from text to speech and from speech to text to the user.

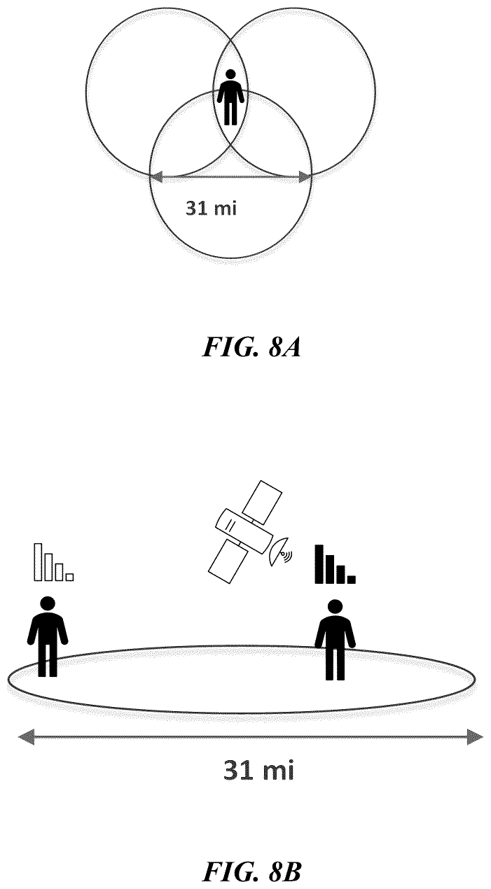

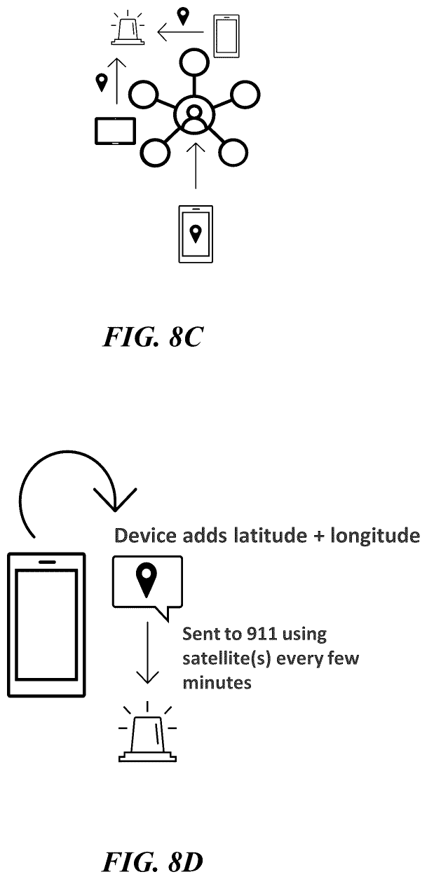

When the user device operates using a restricted connection, because the cellular network is not available to provide more accurate locations of devices, additional mechanisms can be used to help improve the accuracy of the locational information about the user device. FIG. 8A illustrates an example trilateration that leverages information from multiple beams or multiple satellites in accordance with one or more embodiments of the present technology. The caller device can more accurately determine its location when there are three or more satellites available for providing network connections. FIG. 8B illustrates an example of using signal strength from the device to determine the distance between the device and the beam/satellite in accordance with one or more embodiments of the present technology. Given a known satellite location, the signal strength can help provide a more accurate estimation of the caller device's location. In some embodiments, nearby devices can be used to help determine the device location. FIG. 8C illustrates an example of using Bluetooth Low Energy (BLE) advertising among devices in accordance with one or more embodiments of the present technology. In some embodiments, the locational information, such as the latitude and longitude positions of the device, can be embedded and transmitted in the text messages periodically or aperiodically, as shown in FIG. 8D.

In some embodiments, the absence of data coverage in restricted networks prevents devices from reporting diagnostics data. In some embodiments, diagnostic data associated with the emergency situation(s) is collected and uploaded to the cellular network when the cellular connection is restored. Example diagnostic data includes emergency round trip time (RRT), start time of the emergency occurrence, and/or end time of the emergency occurrence. Gathering diagnostics data can provide insights into emergency response time, call routing, and/or device performance in restricted connection mode. The diagnostic data can also be used for post-incident analysis and reporting. Because a limited amount of storage is available on the devices, the collection of diagnostic data is performed for a set amount of time, and overwriting existing data can occur once a threshold amount of time is reached.

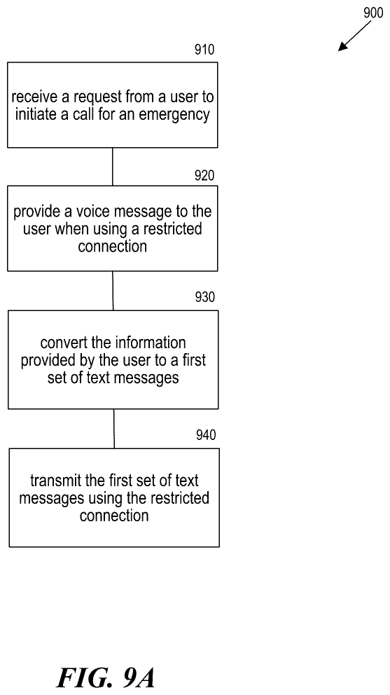

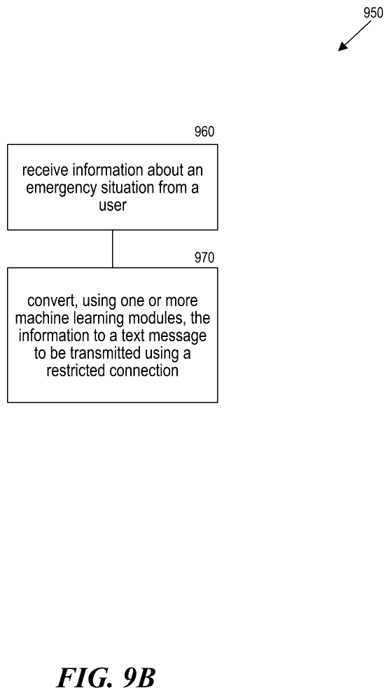

FIG. 9A is a flowchart representation of a method for wireless communication in accordance with one or more embodiments of the present technology. The method 900 includes, at operation 910, receiving a request from a user to initiate a call for an emergency using a mobile device. The method 900 includes, at operation 920, providing a voice message to the user upon determining that the mobile device is operating using a restricted connection, e.g., a satellite connection. The voice message prompts the user to provide information about the emergency. The information includes at least voice data from the user. The method 900 includes, at operation 930, converting the information provided by the user to a first set of text messages. The first set of text messages further comprises location information of the mobile device. The method 900 includes, at operation 940, transmitting the first set of text messages to an emergency service using the restricted connection, e.g., the satellite connection.

In some embodiments, the method includes receiving a second set of text messages from the emergency service in response to the first set of text messages and converting the second set of text messages to voice information to the user. In some embodiments, the information further comprises touchtone selection provided by the user. In some embodiments, converting of the information comprises generating the first set of text messages using one or more machine learning modules deployed on the mobile device.

In some embodiments, the location information comprises at least one of: latitude information of the mobile device, longitude information of the mobile device, ALI, or ANI. In some embodiments, the method includes providing a user interface to the user to initiate the call for the emergency. The user interface is the same as the one for the user to initiate an emergency call using a cellular connection. In some embodiments, the method includes collecting metrics data associated with the call. The metrics data comprises at least one of: coverage information of the satellite connection, a response time of the call, routing information for the call, or performance information of the mobile device. The method also includes transmitting, when the mobile device operates using a cellular connection, the metrics data to a core network via the cellular connection.

FIG. 9B is a flowchart representation of a method for information conversion in accordance with one or more embodiments of the present technology. In some embodiments, the method 950 can be implemented as part of the AI/ML system shown in FIG. 6. The method 950 includes, at operation 960, receiving information about an emergency situation from a user. The information comprises voice data from the user. The method 950 includes, at operation 970, converting, using one or more machine learning modules, the information comprising at least the voice data to a text message to enable the text message to be transmitted using a restricted connection, e.g., satellite connection. The one or more machine learning modules are trained to recognize accent information or one or more languages.

In some embodiments, the method includes converting, using the one or more machine learning modules, a response text message to voice information for the user. The response text message is received by the device in response to the information about the emergency situation. In some embodiments, the method includes updating the text message by appending locational information of the device to the text message. In some embodiments, the information further comprises touchtone selection information provided by the user. In some embodiments, the method includes filtering background noises from the voice data provided by the user. In some embodiments, the one or more machine learning modules are downloaded from a server in a cellular network to be deployed to the device.

### Computer System

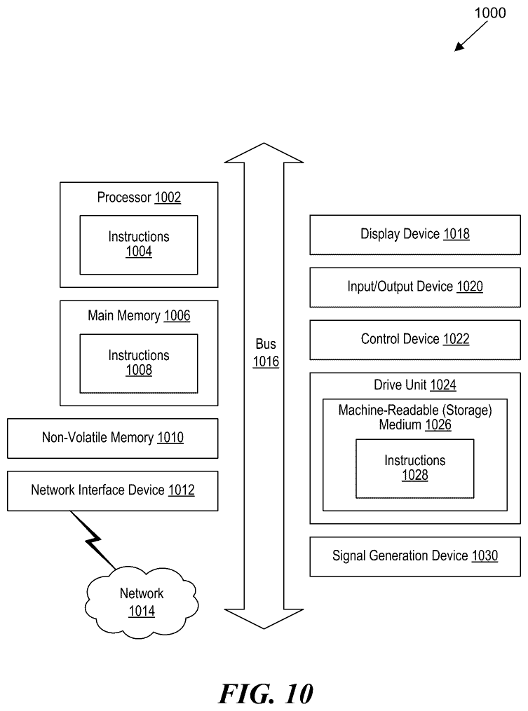

FIG. 10 is a block diagram that illustrates an example of a computer system 1000 in which at least some operations described herein can be implemented. As shown, the computer system 1000 can include: one or more processors 1002, main memory 1006, non-volatile memory 1010, a network interface device 1012, a video display device 1018, an input/output device 1020, a control device 1022 (e.g., keyboard and pointing device), a drive unit 1024 that includes a machine-readable (storage) medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementations, the computer system 1000 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for wireless communication, comprising:
receiving a request from a user to initiate a call for an emergency using a mobile device;
providing a voice message to the user upon determining that the mobile device is operating using a satellite connection,
wherein the voice message prompts the user to provide information about the emergency, the information comprising voice data from the user;
converting the information provided by the user to a first set of text messages,
wherein the first set of text messages further comprise location information of the mobile device; and
transmitting the first set of text messages to an emergency service using the satellite connection.

2. The method of claim 1, further comprising:
receiving a second set of text messages from the emergency service in response to the first set of text messages; and
converting the second set of text messages to voice information to the user.

3. The method of claim 1, wherein the information further comprises touchtone selection provided by the user.

4. The method of claim 1, wherein the converting the information comprises:
generating the first set of text messages using one or more machine learning modules deployed on the mobile device.

5. The method of claim 1, wherein the location information comprises at least one of: latitude information of the mobile device, longitude information of the mobile device, automatic location identification (ALI), or automatic number identification (ANI).

6. The method of claim 1, comprising:
providing a user interface to the user to initiate the call for the emergency,
wherein the user interface is same as one for the user to initiate an emergency call using a cellular connection.

7. The method of claim 1, comprising:
collecting metrics data associated with the call,
wherein the metrics data comprises at least one of: coverage information of the satellite connection, a response time of the call, routing information for the call, or performance information of the mobile device; and
transmitting, upon the mobile device operating using a cellular connection, the metrics data to a core network via the cellular connection.

8. A device for wireless communication, comprising at least one processor that is configured to cause the device to:
receive a request from a user to initiate a call for an emergency;
provide a voice message to the user upon determining that the device is operating using a restricted connection,
wherein the voice message prompts the user to provide information about the emergency, the information comprising at least voice data from the user;
convert the information provided by the user to a first set of messages; and
transmit the first set of messages to an emergency service using the restricted connection.

9. The device of claim 8, wherein the at least one processor is configured to cause the device to:
receive a second set of messages from the emergency service in response to the first set of messages; and
convert the second set of messages to voice information to the user.

10. The device of claim 8, wherein the information further comprises touchtone selection provided by the user.

11. The device of claim 8, wherein the at least one processor is configured to cause the device to convert the information based on:
generating the first set of messages using one or more machine learning modules deployed on the device.

12. The device of claim 8, wherein the first set of messages comprises location information of the device, wherein the location information comprises at least one of: latitude information of the device, longitude information of the device, automatic location identification (ALI), or automatic number identification (ANI).

13. The device of claim 8, wherein the at least one processor is configured to cause the device to:
provide a user interface to the user to initiate the call for the emergency,
wherein the user interface is same as one for the user to initiate an emergency call using a cellular connection.

14. The device of claim 8, wherein the at least one processor is configured to cause the device to:
collect metrics data associated with the call,
wherein the metrics data comprises at least one of: coverage information of the restricted connection, a response time of the call, routing information for the call, or performance information of the device; and
transmit, upon the device operating using a cellular connection, the metrics data to a core network via the cellular connection.

15. A non-transitory, computer-readable storage medium comprising instructions recorded thereon, wherein the instructions when executed by at least one processor of a device, cause the device to:
receive information about an emergency situation from a user,
wherein the information comprises voice data from the user;
convert, using one or more machine learning modules, the information comprising at least the voice data to a text message to enable the text message to be transmitted using a satellite connection,
wherein the one or more machine learning modules are trained to recognize accent information or one or more languages.

16. The non-transitory, computer-readable storage medium of claim 15, wherein the instructions cause the device to:
convert, using the one or more machine learning modules, a response text message to voice information for the user,
wherein the response text message is received by the device in response to the information about the emergency situation.

17. The non-transitory, computer-readable storage medium of claim 15, wherein the instructions cause the device to:
update the text message by appending locational information of the device to the text message.

18. The non-transitory, computer-readable storage medium of claim 15, wherein the information further comprises touchtone selection information provided by the user.

19. The non-transitory, computer-readable storage medium of claim 15, wherein the instructions cause the device to:
filter background noises from the voice data provided by the user.

20. The non-transitory, computer-readable storage medium of claim 15, wherein the one or more machine learning modules are downloaded from a server in a cellular network to be deployed to the device.
